(19) United States
(12) Patent Application Publication
(10) Pub. No.: US 2016/0029599 A1
(43) Pub. Date: Feb. 4, 2016

(54) SYSTEM, METHOD, AND ARTICLE FOR PET WASTE COLLECTION

(71) Applicant: Viki Dream Bailey, Brooklyn, NY (US)

(72) Inventor: Viki Dream Bailey, Brooklyn, NY (US)

(21) Appl. No.: 14/731,679

(22) Filed: Jun. 5, 2015

Related U.S. Application Data
(60) Provisional application No. 61/998,340, filed on Jun. 25, 2014.

(51) Int. Cl. A01K 23/00; A01K 27/00

(52) U.S. Cl. CPC A01K 23/00; A01K 27/002

(57) ABSTRACT

A dog waste collection elastic harness includes a disposable elastic harness and a waste bag. The elastic harness is attached to a dog to its upper tail set region. The dog waste collection systems further contains a plurality of adjustable side straps to adjust the size of the elastic harness to various sizes.

### TECHNICAL FIELD

The present invention relates to a device for collection of animal waste.

### BACKGROUND

Various localities require that pet owners should remove droppings that their pets leave in public places and dispose them off at proper dumping place. While some pet owners ignore this requirement, others use various tools available for this unpleasant task. Many pet owners resort to the “bag-in-hand” method (alternatively called the “hand-in-bag” method). Using a plastic grocery bag, the pet owner inserts their hand in the bag and hand scoops the pet waste, closes the bag, and disposes of the waste in a trash receptacle. The next device the pet owners use while walking the pet is the poop scooper, usually which has a handle on the device to scoop up the waste after the pet has released the poop. The poop scooper usually have a handle on one end and a scoop on the other to pick up the poop or followed by the pet owner by bending down with a disposable waste bag to pick up the poop after the pet releases it on the ground. However, the person walking the dog may have health problem that does not allow the person to bend over toward the ground to pick up the poop with a plastic bag wrapped around the hand. Further, there is a need for a comfortable handle and a means to be able to hold the dog firmly when picking up the poop on the ground with the scooper. Further, some owners have multiple dogs and a coupler having some or all of the features would be desirable.

### SUMMARY

The present disclosure presents an adjustable elastic harness including a bag for waste collection of an animal. The elastic harness includes a trap that hugs the upper tail set region of a dog. The elastic harness further comprises multiple side straps that surround the strap and the bag. The side straps are adapted to be adjustable with the help of a sliding mechanism on the side straps.

In another aspect of the invention an article for collection of animal waste is provided. The article includes a main strap that is adapted to be wrapped around the tail set region of an animal. The article, further contains a set of side straps which are connected from one end portion to the main strap and to a bag portion from another end. The bag portion includes a disposable bag configured to hang below the waste removal portion of the animal, which collects the waste as it is released from the animal. The whole of the article can then be disposed of making the article thus hands free.

Additional features and advantages are realized through the techniques of the present disclosure. Other embodiments and aspects of the present disclosure are described in detail herein and are considered a part of the present disclosure. For a better understanding of the present disclosure with advantages and features, refer to the description and to the drawings.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a view in perspective of an elastic harness in accordance with the present invention illustrating it being surrounding the dog upper high tail set region.

FIG. 1A is a view distinguishing the around the head leash from the upper thigh tail set region harness.

FIG. 2 is a view in perspective of the elastic harness being attached to a disposable waste bag.

FIG. 3 is a top view in perspective of the elastic harness attached to the disposable waste bag.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies.

Although the invention may be beneficial to many types of pets, such as cats, ferrets, pigs, and the like however, the most common use of the invention is likely with dogs.

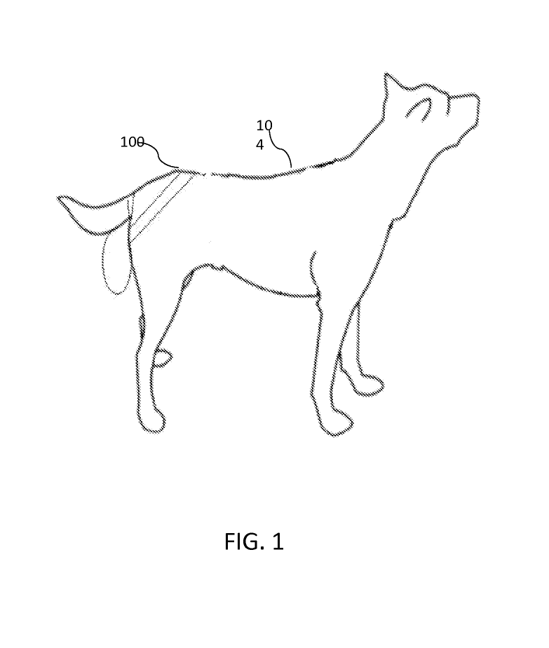

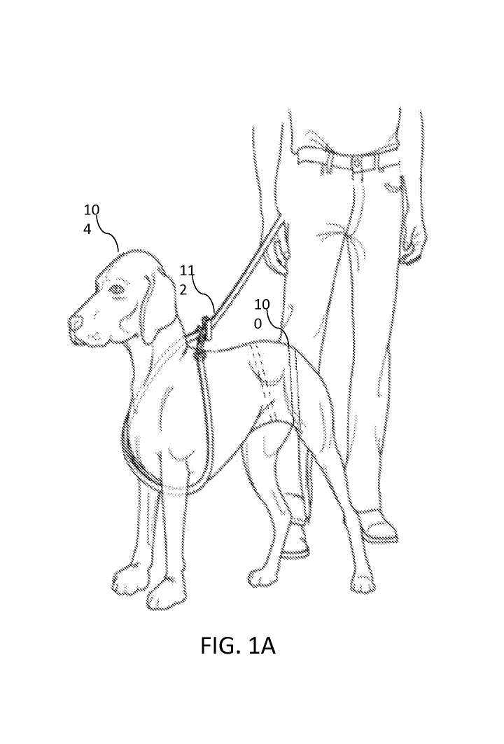

Referring to FIG. 1 which illustrates a perspective view of an elastic harness in accordance to an embodiment of the invention where an elastic harness 100 is disposed on a dog 104 around tail set region of the dog 104. In an embodiment of the invention the elastic harness 100 is fully disposable thereby making it particularly hands free arrangement for dog waste collection.

Referring to FIG. 1A which provides a distinguishing view of the elastic harness 100 that is disposed around the tail set region of the dog 104 as compared to around the head, leash harness 112. The elastic harness 100 as according to the proposed invention is disposed of around the tail set region of the dog 104.

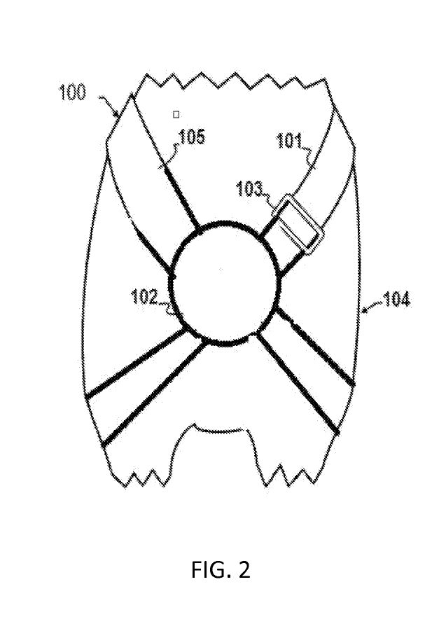

Referring to FIG. 2 that depicts a perspective view of the elastic harness 100 that to its one end has a disposable waste bag 102. The waste bag 102 is made up of adjustable disposable material. The waste bag is placed below the waste release area of the dog 104. The waste bag 102 may be made up of biohazard disposable plastic. The waste bag 102 may be similar to that of a hand handled dog waste bags and is preferably biohazard disposable bag, but may be made up of other materials including other suitable biohazard material and various plastics.

The elastic harness 100 may include side straps 101, 105 that surround the elastic harness 100 and the disposable waste bag 102. In an embodiment of the invention the side straps 101, 105 may be of any length and any width. In other embodiments, the side straps 101, 105 as illustrated in FIG. 2 are for the coupling to one dog 104 (not shown in the figure) to an elastic harness 100. The elastic harness 100 may be constructed with two, three or four or more straps to provide coupling to the dog 104 however, not limiting to the scope of the invention.

In an embodiment of the invention the side strap 101 may contain a sliding mechanism 103 in order to adjust the length the elastic harness 100 to fit to dogs of various sizes. The sliding mechanism 103 could be a buckle that is configured to slide. The sliding movement of the buckle 103 loosens or tightens the elastic harness 100.

In another embodiment of the invention the side straps 101, 105 may form an X-type arrangement. However, there may be other arrangements as may be apparent to a person skilled in the art.

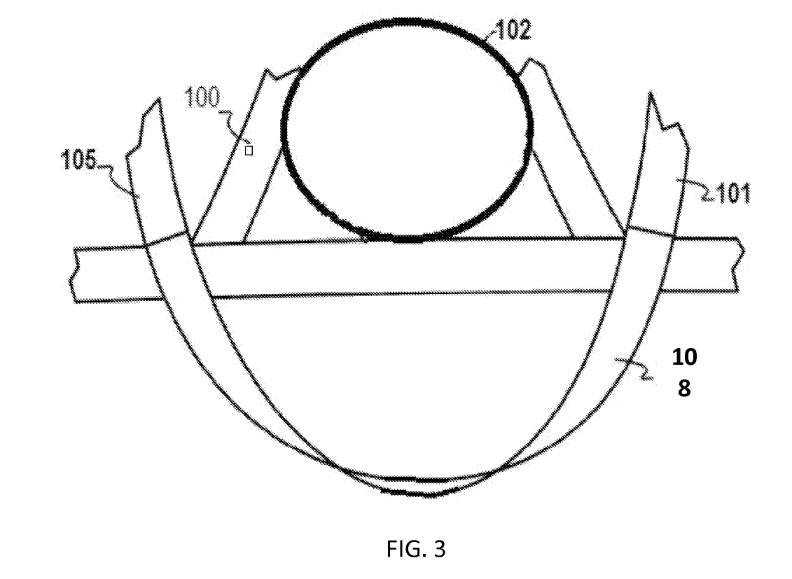

Referring now to FIG. 3 that is a top view in perspective of the elastic harness attached to the disposable waste bag. The elastic harness 100 contains side straps 101, 105. The elastic harness 100 hugs the upper tail set region 108 of the dog 104 (not shown in the figure).

As discussed above, the thickness of the adjustable elastic harness 100 and disposable waste bags 102, may be made in various sizes to accommodate dogs of different sizes. The adjustable disposable elastic harness 100 may be of various widths and it is presently preferred that three widths be provided. However, it is understood that various other widths may be utilized in practicing the present invention. In other words, it may be desirable to use a larger diameter elastic harness 100 and larger size waste bags 102 for larger dogs 104 and smaller elastic harness 100 and smaller size waste bags 102 for smaller dogs 104.

Some presently preferred size dimensions are provided and described herein for the purposes of illustration. Four presently preferred sizes are contemplated, namely small, medium, large and extra-large. In each case the length of the elastic harness 100 and waste bags 102 in its unstretched condition would be provided. The width of the elastic harness, which are preferably X shaped, would match the width of the adjustable disposable elastic harness 100 and waste bags 102.

Exemplary Elastic harness sizes:

Small Elastic Harness
3/16 inch I.D. (Inner diameter); ⅛ inch wall thickness—⅝ inch wide

Medium Elastic Harness
¼ inch I.D.; ⅛ inch wall thickness—⅝ inch wide

Large Elastic Harness
¼ inch I.D.; 3/16 inch wall thickness—¾ inch wide

Extra-Large Elastic Harness
5/16 inch I.D.; 3-16 inch wall thickness—1 inch wide

Exemplary waste bag sizes:

Smaller Waste Bag
6 inch length; 3/16 inch I.D.; ⅛ inch wall thickness—6 inch length; ⅝ inch width

Medium Waste Bag
8 inch length; ¼ inch I.D.; ⅛ inch wall thickness—8 inch length; ⅝ inch width

Large Waste Bag
10 inch length; ¼ inch I.D.; 3/16 inch wall thickness—10 inch length; ¾ inch width

Extra-Large Waste Bag
12 inch length; 5/16 inch I.D.; 3/16 inch wall thickness—12 inch length; 1 inch width

The elastic harness 100 may be of any color, but is preferable to be of a brightly fluorescent color such as yellow, blue, pink, purple, red, lemon, green orange, or any other bright color which makes the disposable adjustable elastic harness 100 readily visible.

The present invention may be embodied in other specific forms without departing from the spirit of essential attributes of the invention.

While there has been shown and described herein what are presently considered the preferred embodiments of the present disclosure, it will be apparent to those skilled in the art that various changes and modifications can be made therein without departing from the scope of the present disclosure as defined by the appended claims.

While certain embodiments have been described, these embodiments have been presented by way of example only, and are not intended to limit the scope of the present disclosure. Indeed, the novel methods, devices, and systems described herein may be embodied in a variety of other forms. Furthermore, various omissions, substitutions, and changes in the form of the methods, devices, and systems described herein may be made without departing from the spirit of the present disclosure. The accompanying claims and their equivalents are intended to cover such forms or modifications as would fall within the scope and spirit of the present disclosure.

What is claimed is:

1. An adjustable harness assembly adapted for attachment to an animal for collecting animal waste, the harness assembly comprising;
a strap configured to be wrapped around upper thigh-tail of the animal;
a bag detachably attached to the strap wherein, the bag is positioned below the waste release area of the animal; and
at least one side strap of adjustable length, wherein the side strap connects the strap and the bag.

2. The adjustable harness assembly of claim 1 wherein, the harness assembly is disposable.

3. The adjustable harness assembly of claim 1 wherein, the at least one side strap is adjustable to surround bags and straps of varied sizes.

4. The adjustable harness assembly of claim 3 wherein, the varied sizes are extra small, small, regular, medium, large, extra-large etc.

5. The adjustable harness assembly of claim 1 wherein, the strap comprises a sliding mechanism to enable the strap to be adjusted to any size.

6. The adjustable harness assembly of claim 1 wherein, the bag is made up of a biohazard disposable material.

7. The adjustable harness assembly of claim 6 wherein, the biohazard disposable material is plastic.

8. An article for collecting animal waste, the article comprising;
a main strap configured to be wrapped around tail set region of the animal;
a plurality of side straps having a first end and a second end wherein, the first end join the main strap and the second end join a bag portion.

9. The article of claim 8 wherein, the bag is positioned below the waste releasing portion of the animal.

10. The article of claim 9 wherein, the animal is a dog.

11. The article of claim 8 wherein, the article is disposable.

12. The bag portion of claim 8 wherein, the bag portion is disposable.

13. The article of claim 8 wherein, the main strap further comprises a sliding buckle to loosen or tighten the main strap so as to vary in size.

14. The article of claim 8 wherein, the plurality of side straps further comprise a sliding buckle to tighten or loosen so as to vary the length.

15. The article of claim 8 wherein, the plurality of side straps may be in an X-shaped arrangement.

16. The article of claim 8 wherein, the main strap is further configured to receive more adjustable side straps.
